(19) United States
(12) Patent Application Publication
(10) Pub. No.: US 2015/0053897 A1
(43) Pub. Date: Feb. 26, 2015

(54) Formation of Nanoparticles of Antimonides Starting from Antimony Trihydride as a Source of Antimony

(71) Applicant: COMMISSARIAT A L'ENERGIE ATOMIQUE ET AUX ENERGIES ALTERNATIVES, Paris (FR)

(72) Inventors: Axel Maurice, Grenoble (FR); Bérangère Hyot, Eybens (FR); Peter Reiss, Saint Egreve (FR)

(21) Appl. No.: 14/382,103

(22) PCT Filed: Feb. 22, 2013
(86) PCT No.: PCT/IB2013/051452

§ 371 Date: Aug. 29, 2014

(30) Foreign Application Priority Data
Feb. 29, 2012 (FR) 1251843

(51) Int. Cl. B01J 13/00

(52) U.S. Cl. CPC B01J 13/00; B82Y 40/00
USPC 252/518.1; 977/896; 977/932; 977/936; 977/953; 977/773

(57) ABSTRACT

The present invention relates to a process for preparing nanoparticles of antimonides of metal element(s) in the form of a colloidal solution, using antimony trihydride (SbH₃) as a source of antimony.

The present invention relates to the field of manufacture of materials based on antimonide nanoparticles. A more particular subject matter of the present invention is in a novel process for the preparation of semiconducting antimonide nanocrystals, in particular indium antimonide (InSb) nanocrystals.

Antimonide nanocrystals may be used in numerous fields, for example in the preparation of photovoltaic cells, light-emitting diodes, photodetectors, gas sensors, thermoelectric devices or fluorescent markers in biology.

Generally, semiconducting nanocrystals, which are crystalline particles having dimensions typically of between a few nanometers and a few tens of nanometers, have formed the subject of numerous studies. Such nanocrystals have proved to be particularly advantageous from the viewpoint of the appearance of a phenomenon of “quantum confinement” in these particles when their size is less than the exciton Bohr radius. This phenomenon is reflected in particular by a significant increase in the forbidden band energy and thus in the ranges of wavelengths which may be absorbed or emitted by the nanocrystal, with respect to the bulk semiconductor. By varying solely the size of the particles of a given semiconductor material, it is thus possible to adjust its optical properties in order to respond to the requirements of the targeted application.

Among the various processes which make it possible to obtain nanocrystals, the chemical synthesis by the colloidal route advantageously makes possible the production, at low cost and in a large amount, of particles having a low size dispersion. This technique gives highly satisfactory results in the case of cadmium chalcogenides (CdS, CdSe and CdTe). However, the RoHS European Directive is targeted at banning the use of such substances for the construction of electronic appliances sold in Europe after July 2006. It therefore appears essential to turn toward alternative materials which do not harm the health of living organisms.

As such, indium antimonide (InSb) constitutes an advantageous option in the light, on the one hand, of its harmlessness and, on the other hand, of its particularly advantageous intrinsic physical properties. Thus, among all the binary semiconductor compounds of the III-V family (composite semiconductors manufactured from an element of Group III of the Periodic Table of the elements and from an element of Group V), indium antimonide is that which has the lowest forbidden bandwidth (Eg=0.176 eV at 300 K) and the broadest exciton Bohr radius (a_{B,ex}=65 nm). Finally, the electron mobility values obtained for indium antimonide may reach 78 000 cm²/Vs (versus 1 450 cm²/Vs in bulk silicon). Theoretical models predict, from these data, that it will be possible to modulate the emission wavelength of InSb nanocrystals within a huge range, extending from the visible to the infrared, by simple control of their size. Indium antimonide thus represents a candidate of first choice for the preparation of optical devices, subject to suitably taking advantage of the strong phenomenon of quantum confinement which may be exerted in this material if the dimensions of the particles are sufficiently low.

In order to fully exploit the performance of this material, it is, however, essential to have available synthetic routes which are efficient and reproducible and which make it possible to result in nanocrystals suited to the targeted application, in particular to their use in optoelectronic devices.

In fact, at the current time, the lithography technique is generally employed in processes for forming many devices based on semiconductor materials. For the sake of simplifying these processes, liquid-route deposition (spin- or spray-coating, for example), printing or inkjet methods may sometimes advantageously replace lithography. However, this involves having available particles which are not aggregated in order to guarantee the deposition of continuous films and, in the case of the inkjet technique, not to block the nozzles.

Generally, the various methods of synthesis employed in order to obtain inorganic nanocrystals are based on the use of liquid or gas phases.

On the one hand, the “physical” approaches take advantage of the spontaneous reorganization of the molecules, on an oriented substrate or within a matrix, resulting in the formation of nanocrystals. By way of example, the radiofrequency magnetron deposition technique employed by Têtu et al. [1] makes it possible to obtain a silica (SiO₂) film comprising indium and antimony atoms. After an annealing operation, these atoms diffuse inside the SiO₂ matrix and form indium antimonide nanocrystals. However, the particles thus obtained are highly polydispersed.

Furthermore, they may not be used for the manufacture of inks owing to the fact that the nanocrystals remain trapped inside the silica layer. Usui et al. [2] describe, for their part, the formation of InSb nanocrystals in an alumina (Al₂O₃) matrix by a similar method which thus exhibits the same disadvantages. Again, according to the study carried out by Glaser et al. [3], the molecular jet epitaxy technique may result in the growth of antimonide (InSb, GaSb and AlSb) nanocrystals on an oriented substrate. This technique takes advantage of the discrepancy in unit cell parameter between the antimonide under consideration, on the one hand, and the substrate, on the other hand, resulting in the spontaneous growth of nanocrystals. Here again, the particles obtained are polydisperse and strongly attached to the substrate. It is thus difficult to detach them therefrom in order to use them in an ink. Furthermore, this method is very expensive as it resorts to the use of specific substrates and to restricting experimental conditions (work under high vacuum).

On the other hand, the “chemical” processes, which make it possible to obtain semiconducting nanocrystals of the III-V family by the colloidal route, are generally still very poorly controlled, because of operating conditions which are not very favorable to the actual nature of the precursors employed. In particular, nanocrystals based on antimonides (AlSb, GaSb and InSb, for example) are very difficult to obtain by the chemical route, for lack of suitable antimony sources. To this end, tris(trimethylsilyl)antimony ((TMS)₃Sb) has already been proposed as antimony source. A method which makes it possible to synthesize this precursor, subsequently capable of providing the supply of Sb atoms necessary for the growth of colloidal antimonide nanocrystals, was presented from 1967 by Amberger et al. [4]. Evans et al. [5] also describe an alternative method for the synthesis of (TMS)₃Sb, which is subsequently employed for the preparation of InSb nanocrystals. Schulz et al. [6] have also resorted to this precursor in order to bring about the growth of gallium antimonide (GaSb) nanocrystals. The main disadvantage of this type of process lies in the fact that the precursor employed, the (TMS)₃Sb, is pyrophoric, light-sensitive and unavailable commercially. Its production is furthermore lengthy and laborious: it has to be carried out under very restrictive conditions, avoiding all contact with air during the phases of synthesis and purification. In addition, particular arrangements have to be taken, given the pyrophoric nature of said compound.

Finally, mention may also be made on the formation of particles based on III-V semiconductor materials by solvothermal reduction. For example, Li et al. [7] employ a reaction of this type in order to obtain InSb and GaSb nanocrystals. The main disadvantage of this approach lies in the fact that the nanocrystals thus obtained are relatively large and very polydispersed (their diameter ranging between 20 and 60 nm).

Thus, it appears that the only chemical synthesis schemes which currently make it possible to produce colloidal nanocrystals based on antimonides having a low size dispersion involve the use of a pyrophoric antimony precursor which is not available commercially and which is highly problematic to prepare. Consequently, the current methods for the synthesis of antimonide nanocrystals do not make it possible to envisage their use on the industrial scale.

The present invention is targeted specifically at providing a novel process which satisfies the abovementioned requirements and which makes it possible in particular to dispense with the use of the precursor (TMS)₃Sb.

More specifically, the inventors have discovered that it is possible to access antimonide nanoparticles by using antimony trihydride (SbH₃) as antimony source.

Thus, the present invention relates, according to a first of its aspects, to a process for the preparation of nanoparticles of antimonides of metal element(s), characterized in that it employs antimony trihydride as antimony source.

The antimonide nanoparticles are more particularly obtained in the form of a colloidal solution.

The term “antimonide” is understood to mean the combination of antimony with one or more metal element(s). Said metal element may in particular be chosen from aluminum (Al), gallium (Ga), indium (In), thallium (Tl), zinc (Zn), cadmium (Cd), iron (Fe), cobalt (Co), nickel (Ni), bismuth (Bi), scandium (Sc), titanium (Ti), vanadium (V), chromium (Cr), manganese (Mn), copper (Cu), rubidium (Rb), strontium (Sr), yttrium (Y), zirconium (Zr), niobium (Nb), ruthenium (Ru), rhodium (Rh), palladium (Pd), silver (Ag), cesium (Cs), barium (Ba), hafnium (Hf), iridium (Ir), platinum (Pt), gold (Au), tin (Sn), lead (Pb) and their mixtures. Mention may be made, as example of antimonides formed of a mixture of two metal elements, of AlInSb and InGaSb.

The term “antimony source” is intended to denote the precursor capable of providing the supply of Sb atoms necessary for the growth of antimonide nanoparticles.

Antimony trihydride (SbH₃) exists in the gas form at temperatures greater than −17° C. This compound is also more commonly denoted under the term “stibine”. The term “antimony trihydride” is understood to denote, within the meaning of the invention, the compound in the gas form.

According to the invention, the term “nanoparticle” is understood to mean in particular a particle of nanocrystal type.

As expanded upon in the continuation of the text, the antimony trihydride may more particularly be formed and injected as it is formed into a liquid medium, subsequently referred to as reaction medium, comprising at least one precursor of a metal element for which it is desired to form the antimonide.

The process of the invention proves to be advantageous on several accounts.

First of all, as expanded upon in the continuation of the text, it makes it possible to readily access antimonide nanoparticles. In particular, it employs solely compounds which are commercially available or easy to obtain, which are inexpensive and which are nonpyrophoric. It thus makes it possible to be freed from the disadvantages related to the use of the (TMS)₃Sb precursor which are mentioned above. In addition, it does not require that the growth of the nanoparticles be carried out at high temperature, which advantageously makes possible reduced production costs, in particular for production on the industrial scale. Finally, the process of the invention exhibits high reproducibility.

Furthermore, the antimonide nanoparticles obtained by the process of the invention exhibit the desired characteristics, in terms in particular of composition, crystallinity, size dispersion and photoluminescence, for their incorporation within optoelectronic devices.

In particular, the nanoparticles obtained according to the invention may be isolated, in other words are not trapped in a matrix or attached to a substrate, which advantageously allows them to be employed by the liquid route or also in an ink for inkjet methods in the preparation of optoelectronic devices. Such nanoparticles may thus be used in solar cells, in photodetectors, light converters, light-emitting diodes, transistors, as fluorescent markers or in chemical or optical sensors.

The process of the invention makes it possible to produce discrete antimonide nanoparticles which are of generally spherical shape, the mean diameter of which is preferably less than or equal to 30 nm.

The term “discrete particles” is intended to denote particles which are not aggregated with one another, in other words not agglomerated, and which may be individually isolated.

According to another of its aspects, the present invention relates to nanoparticles of antimonides of metal element(s) obtainable according to the process of the invention.

It also relates to a colloidal solution of nanoparticles of antimonides of metal element(s) obtainable by the process defined above.

The nanoparticles may more particularly be employed in the form of a colloidal solution in a solvent, in particular in a nonpolar solvent, such as, for example, hexane, toluene or chloroform. The colloidal solutions formed from the nanoparticles of the invention exhibit good stability properties.

According to another of its aspects, the present invention relates to a colloidal solution of indium antimonide nanoparticles, comprising nanocrystals crystallized according to the In_{0.5}Sb_{0.5} cubic phase and nanocrystals crystallized according to the In_{0.4}Sb_{0.6} phase, with said nanoparticles exhibiting a size dispersion of less than 30%.

It is possible to access such a colloidal solution via the process of the invention defined above.

According to yet another of its aspects, the present invention relates to a colloidal solution of nanoparticles obtained by suspending nanoparticles as defined above in a solvent.

According to yet another of its aspects, the present invention is targeted at the use of these nanoparticles or of a colloidal solution as are defined above in solar cells, photodetectors, light converters, light-emitting diodes, transistors, as fluorescent markers or in chemical or optical sensors.

Other characteristics, alternative forms and advantages of the process, of the nanoparticles and of their use according to the invention will more clearly emerge on reading the description, the examples and the figures which follow, which are given by way of illustration and not by way of limitation of the invention.

In the continuation of the text, the expressions “of between . . . and . . . ”, “ranging from . . . to . . . ” and “varying from . . . to . . . ” are equivalent and are understood to mean that the limits are included, unless otherwise mentioned.

Unless otherwise mentioned, the expression “comprising a” should be understood as “comprising at least one”.

### Process

The process of the invention is more particularly targeted at the formation of antimonide nanoparticles, the metal element of which is chosen from aluminum (Al), gallium (Ga), indium (In), thallium (Tl), zinc (Zn), cadmium (Cd), iron (Fe), cobalt (Co), nickel (Ni), bismuth (Bi), scandium (Sc), titanium (Ti), vanadium (V), chromium (Cr), manganese (Mn), copper (Cu), rubidium (Rb), strontium (Sr), yttrium (Y), zirconium (Zr), niobium (Nb), ruthenium (Ru), rhodium (Rh), palladium (Pd), silver (Ag), cesium (Cs), barium (Ba), hafnium (Hf), iridium (Ir), platinum (Pt), gold (Au), tin (Sn), lead (Pb) and their mixtures.

According to a specific embodiment, the process of the invention makes possible the formation of antimonide nanoparticles, the metal element(s) of which is (are) chosen from aluminum, gallium, indium, thallium and their mixtures.

Preferably, the process of the invention makes it possible to form indium antimonide (InSb) nanoparticles.

The process of the invention more particularly comprises at least one stage in which antimony trihydride and at least one precursor of a metal element are brought together under conditions favorable to the formation of said nanoparticles.

According to a specific embodiment, the process of the invention comprises at least the stages consisting in:
(i) providing a liquid medium, subsequently referred to as “reaction medium”, comprising at least one precursor of a metal element for which it is desired to form the antimonide and at least one solvent; and
(ii) bringing together the antimony trihydride and said reaction medium under conditions favorable to the formation of said nanoparticles.

Stage (ii) more particularly comprises the injection of the antimony trihydride into said reaction medium.

### Reaction Medium

### Precursor of the Metal Element

Said precursor of the metal element may be the complex of said metal element with a fatty acid, in particular having a saturated or unsaturated and linear or branched carbon chain comprising between 4 and 36 carbon atoms, preferably a linear alkyl chain comprising between 12 and 18 carbon atoms.

Said fatty acid may more particularly be chosen from lauric acid, myristic acid, palmitic acid, stearic acid and oleic acid.

By way of example, an indium precursor may be indium myristate.

According to a specific embodiment, said precursor of the metal element may be formed beforehand by reaction in a solvent, in particular under low vacuum, of an organic or inorganic salt of said metal element with a fatty acid having a saturated or unsaturated and linear or branched carbon chain comprising between 4 and 36 carbon atoms, preferably a linear alkyl chain comprising between 12 and 18 carbon atoms.

The organic or inorganic salt of said metal element is chosen in accordance with the general knowledge of a person skilled in the art and typically, for example, from metal acetates, acetylacetonates and halides.

The solvent is an organic compound exhibiting a boiling point of greater than 150° C., in particular chosen from saturated or unsaturated hydrocarbons, such as 1-octadecene.

The precursor of the metal element may be present in the reaction medium in a proportion of 1 to 100 millimol per liter.

The reaction for the formation of said precursor of the metal element from the mixture of the salt of said metal element and of the fatty acid may more particularly be carried out at a temperature T₁ ranging from 25 to 200° C., under vacuum or at ambient pressure.

By way of example, indium myristate may be obtained by reaction of indium acetate (In(Ac)₃) and myristic acid, in particular at a temperature of 220° C. under argon for fifteen minutes.

Said fatty acid or acids may be present in a proportion of 1 to 6 molar equivalents, with respect to the organic or inorganic salt of the metal element.

Said metal precursor may be generated within the reaction medium prior to the stage (ii) of introduction of the antimony trihydride.

Of course, a person skilled in the art will be in a position to adjust the experimental conditions or to employ other alternative forms of forming said precursor.

According to a specific embodiment, the reaction medium may additionally comprise one or more coligands. The presence of one or more coligands makes it possible to influence the size of the nanoparticles or else also to reduce their size dispersion.

Said coligand(s) may more particularly be chosen from amines, in particular octylamine, decylamine, dodecylamine, tetradecylamine, hexadecylamine or oleylamine. Preferably, dodecylamine is concerned.

According to a specific embodiment, said coligand(s) may be present in the reaction medium in a proportion of 1 to 6 molar equivalents, with respect to the precursor of the metal element.

### Preparation of the Antimony Trihydride

The antimony trihydride may be produced from an aqueous solution of acidic pH (less than 7) of antimony potassium tartrate, and potassium borohydride.

More particularly, the antimony trihydride may be generated by addition to a solution of acidic pH, for example of sulfuric acid, of a mixture of antimony potassium tartrate and potassium borohydride maintained at basic pH, for example in a potassium hydroxide solution.

In particular, the reaction for the formation of the antimony trihydride is carried out under an inert atmosphere, for example under an argon or nitrogen atmosphere.

It is, of course, up to a person skilled in the art to adjust the experimental conditions in order to form the antimony trihydride. An example of a method for the production of the antimony trihydride is presented in the examples which follow.

According to a specific embodiment, the antimony trihydride is formed simultaneously with its use in stage (ii).

### Formation of the Antimonide Nanoparticles

As mentioned above, the process of the invention may comprise the injection of the antimony trihydride into the reaction medium as described above.

Preferably, the antimony trihydride is formed, for example according to the method described above, simultaneously with its introduction into said reaction medium.

The process of the invention may thus comprise the following stages consisting in:

(a) producing the antimony trihydride, in particular from an aqueous solution of acidic pH of antimony potassium tartrate, and potassium borohydride; and

(b) bringing together the antimony trihydride formed in stage (a) and said reaction medium comprising at least one precursor of said metal element, under conditions favorable to the formation of the antimonide nanoparticles,

said stages (a) and (b) being carried out continuously.

In other words, the antimony trihydride is introduced into the reaction medium as it is formed. Such a process may, for example, be carried out using a suitable installation, as described in the continuation of the text and illustrated by the experimental set-up of FIG. 1.

Preferably, the reaction medium is maintained at a temperature T₂ ranging from 140 to 250° C., preferably from 150° C. to 220° C., throughout the duration of the formation of the antimonide nanoparticles.

Preferably, the reaction medium is maintained under an inert atmosphere, for example under an argon atmosphere, throughout the duration of the formation of the antimonide nanoparticles.

A person skilled in the art is able to adjust the experimental conditions for the implementation of the process of the invention, in terms, for example, of temperature of the reaction medium, from the viewpoint of the desired size of the nanoparticles.

The antimonide nanoparticles are more particularly obtained in the form of a colloidal solution of nanoparticles.

The process may comprise one or more subsequent stages of washing and/or purifying the nanoparticles.

According to a specific embodiment, the process of the invention may comprise a subsequent stage of thermal annealing of the nanoparticles. This annealing stage makes it possible to increase the crystallinity of the nanoparticles formed.

This annealing may be carried out a temperature T₃ ranging from 200 to 300° C., in particular of approximately 220° C., especially under an inert atmosphere. It may be carried out for a period of time ranging from 30 minutes to 4 hours, in particular for approximately 1 hour.

Preferably, the annealing is carried out in situ, so as to avoid bringing the solution into contact with the ambient air.

Of course, the conditions of the annealing and in particular of temperature are related to the antimonide under consideration, in accordance with the general knowledge of a person skilled in the art.

The mean diameter of the antimonide nanoparticles obtained may be of between 2 and 150 nm, in particular between 5 and 85 nm. The mean diameter may be evaluated by scanning transmission electron analysis (STEM).

Preferably, the antimonide nanoparticles obtained according to the process of the invention exhibit a mean diameter of less than or equal to 30 nm, preferably of less than or equal to 20 nm.

Furthermore, the nanoparticles obtained exhibit a good size dispersion, in particular of less than or equal to 30% and preferably of less than or equal to 20%.

In particular, the nanoparticles may exhibit a size dispersion ranging from 20% to 30%. The size dispersion may be evaluated by analysis of the nanocrystals by STEM.

The antimonide nanoparticles obtained may be suspended in a solvent, in particular in a nonpolar solvent, such as, for example, hexane, toluene or chloroform, in order to form a stable colloidal solution.

### Installation for the Production of the Antimonide Nanoparticles

The process of the invention may be implemented using a suitable installation for the production of antimonide nanoparticles comprising at least:
a first vessel, in which the antimony trihydride is produced; and
a second vessel, in which the reaction medium comprising at least one precursor of the metal element for which it is desired to form the antimonide is present;

said first and second vessels being connected via a fluid communication channel capable of providing for the passage of the antimony trihydride from the first vessel as far as into the reaction medium of the second vessel.

By way of illustration of such an installation, FIG. 1 presents an experimental laboratory set-up. This set-up is composed more particularly of a first round-bottomed flask (1) in which the reaction medium comprising in particular said metal precursor is formed, of a second round-bottomed flask (2) in which the antimony trihydride is formed and of a pipe (3) which connects the two round-bottomed flasks and which makes possible the injection of the antimony trihydride generated from the round-bottomed flask (2) toward the round-bottomed flask (1).

Preferably, the entire set-up is maintained, during the implementation of the process of the invention, under an inert atmosphere, in particular under an argon or nitrogen atmosphere.

Of course, such a set-up may be adapted for production of the antimonide nanoparticles on the industrial scale. It is up to a person skilled in the art to introduce other elements appropriate to the installation for the production of the antimonide nanoparticles according to the invention.

The examples and figures presented below are given solely by way of illustration and without implied limitation of the invention.

### FIGURES

FIG. 1: Diagram of a set-up used for the formation of the antimonide nanoparticles.

FIG. 2: X-ray diffraction diagrams of the indium antimonide nanoparticles obtained according to the protocols described in examples 2.1. (curve a) and 2.2. (curve b).

FIG. 3: STEM photograph of the InSb nanoparticles obtained according to the protocol described in example 2.1. after purification and HRTEM photograph (box) of an isolated indium antimonide nanoparticle.

FIG. 4: STEM photograph of the InSb nanoparticles obtained according to the protocol described in example 2.2. after purification.

FIG. 5: Diagram of the set-up used for the formation of the indium antimonide nanoparticles in example 2.3.

FIG. 6: STEM photograph (FIG. 6.a) and histogram of the size dispersion (FIG. 6.b) of the InSb nanoparticles obtained according to the protocol described in example 2.3.; HRTEM photograph (FIG. 6.c) and Fourier transform (FIG. 6.d) of an isolated nanoparticle.

### EXAMPLES

### Example 1

### Set-up Suitable for the Implementation of the Process for the Preparation of the Antimonide Nanocrystals

1^{st} Part of the Set-Up: Reaction Medium

A first set-up is formed of the three-necked flask (1) in which the reaction medium is preprepared at the temperature T₁ (80° C.) under an inert atmosphere. The round-bottomed flask is connected to a water-cooled reflux condenser, itself connected to a vacuum line positioned in a fume cupboard. These operations are carried out so that the reaction medium remains under an inert atmosphere for the whole of the process (“Schlenk” technique). The unused necks of the three-necked flask are blocked using septa.

The upper end of the reflux condenser is connected to a trap (4) containing an aqueous silver nitrate (AgNO₃) solution (concentration 3×10⁻² mol/l) in order to make it possible to neutralize the SbH₃ molecules which did not react during the growth of the nano crystals.

Once the reaction medium is formed, the circulation of inert gas (argon) is established in the set-up and the temperature of the medium is brought to T₂ (140-250° C.) using heating by heating plate (5) and oil bath, and control of the temperature via a thermometer.

2^{nd} Part of the Set-Up: Formation of the Antimony Trihydride

The central neck of a second three-necked flask (2), in which the antimony trihydride will be produced, is connected to a drying column (6) containing a few grams of phosphorus pentoxide (P₂O₅) powder. Another neck of the round-bottomed flask (2) is subsequently connected to the vacuum line in order to establish circulation in inert gas (argon) in the set-up, while the final orifice of the three-necked flask has, for its part, been blocked by a septum. Finally, the top of the drying column is connected to the three-necked flask (1) via a pipe (3) terminated by a metal needle which care will be taken to immerse in the reaction medium through one of the two free septa of the three-necked flask (1).

The antimony trihydride thus produced, dried and then conveyed to the round-bottomed flask (1), will be decomposed in the reaction medium, resulting in the germination and in the growth of the nanocrystals of antimonide of the element M. The excess gas will be neutralized by reaction with silver nitrate in the trapping device (4) located at the outlet of the reflux condenser.

### Example 2

The processes expanded upon in examples 2.1. and 2.2. which follow were carried out using a set-up described in example 1.

All the materials employed in these processes, which exhibit high sensitivity to air, are handled under an inert atmosphere, either inside a glove box or by employing a vacuum/argon line.

The following products were acquired from Sigma-Aldrich and used as is: indium acetate (purity 99.99%), antimony potassium tartrate (purity 99.95%), myristic acid (purity >99%), dodecylamine (purity >99.5%), potassium borohydride (purity >98%) and 1-octadecene (purity 90%).

### 2.1. Synthesis of InSb Nanocrystals with a Mean Size of 12 nm

The protocol employed starting from the set-up described in example 1 is as follows:

The following are introduced into the three-necked flask (1):

0.1 mmol of indium acetate (In(Ac)₃)

0.3 mmol of myristic acid (MA)

0.3 mmol of dodecylamine (DDA)

8.6 ml of 1-octadecene (ODE).

The mixture is first placed under stirring and an inert atmosphere and then brought to a temperature of approximately 80° C. under low vacuum for approximately one hour in order to allow it to degass. After having re-established the argon circulation, the solution is heated at 220° C. for approximately fifteen minutes in order to form the indium precursor (indium myristate). The solution present in the round-bottomed flask (1) is then brought back to a temperature of 155° C.

The three-necked flask (2) is in its turn placed under an inert atmosphere and approximately 3 ml of 1 mol/l sulfuric acid solution, degassed beforehand, are introduced therein. 1.5 ml of 0.8 mol/l potassium hydroxide (KOH) solution (likewise degassed) are subsequently added to the glass flask (a) already containing 0.15 mmol of antimony potassium tartrate (APT). After complete dissolution (an ultrasound bath may advantageously accelerate the process), the mixture is transferred into the flask (b) in which 0.23 mmol of potassium borohydride (KBH₄) will have been deposited. The combined mixture is then injected as rapidly as possible into the round-bottomed flask (2) in order to start the production of SbH₃.

The pH of the mixture prepared in the flask (b), which is initially basic, is, in contact with acid present in the round-bottomed flask (2), brought to a value of less than 7. This has the effect of initiating the reaction between the APT and KBH₄ powders and of starting, with stirring, the production of the antimony trihydride. The translucent solution present in the round-bottomed flask (2) then rapidly assumes a black coloration.

During the first minutes of synthesis, the initially colorless reaction medium present in the round-bottomed flask (1) rapidly becomes pale yellow. The coloration subsequently changes in a few minutes to dark yellow and then to brown-black, a sign of the growth of the nanocrystals. After a quarter of an hour, counting from the start of the production of the antimony trihydride, the gas injection needle is removed from the three-necked flask (1) and immersed in a trap containing a silver nitrate solution.

The nanocrystals thus obtained are annealed at 220° C. for forty-five minutes.

The mixture is subsequently rapidly cooled down to 70-80° C. and then injected into a vessel containing approximately 5 ml of toluene in order to prevent the solidification of the dodecylamine (melting point: 27-29° C.).

On two occasions, the final product is precipitated using methanol and then separated by centrifuging before being redispersed in a few milliliters of chloroform. A stable colloidal solution of InSb nanocrystals in chloroform is thus obtained.

### Characterization of the Nanocrystals

The energy dispersive analysis (EDX) (EDS-X microanalysis on JEOL 840A SEM) reveals that the particles produced are approximately 42% composed of indium and 58% composed of antimony.

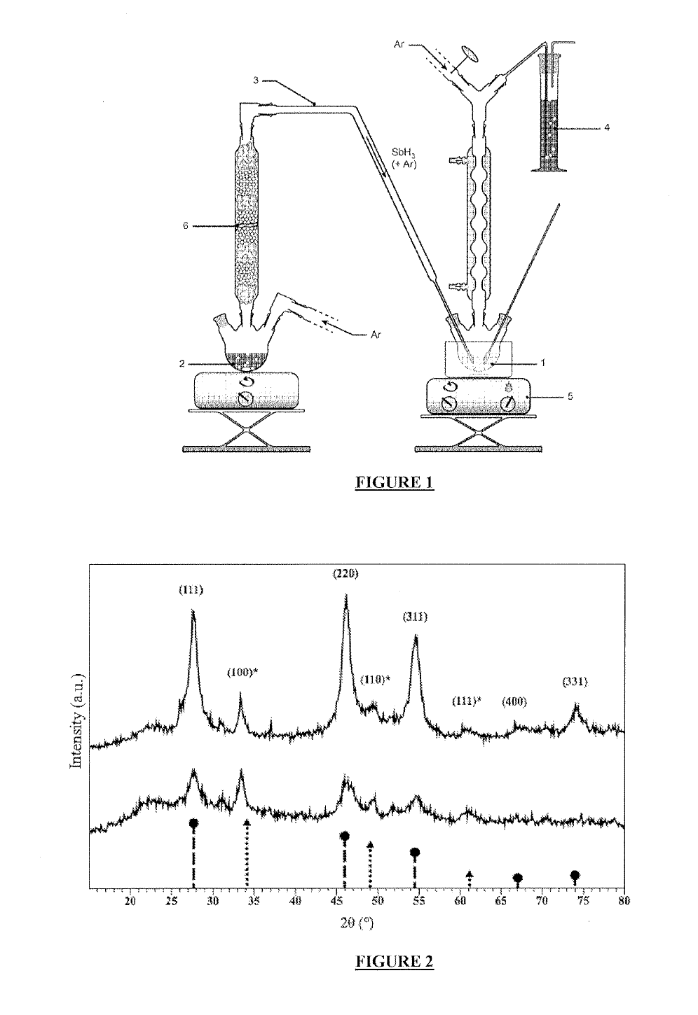

The X-ray diffraction diagram (FIG. 2, curve a) is carried out on a deposit of these nanocrystals which are purified and deposited on a misoriented silicon substrate. This diffraction diagram was recorded by a Philips X'Pert device having a cobalt source operating at 50 kV and 35 mA. The X-ray diffraction diagram obtained comprises peaks corresponding to a “zinc blende” structure identical to that of the bulk indium antimonide (JCPDS card No. 04-001-0014). Other peaks, which are less intense, would appear to originate from a cubic crystalline phase slightly richer in antimony of the In_{0.4}Sb_{0.6} type (JCPDS card No. 01-074-5940), pinpointed by means of asterisks (*) in FIG. 2.

For the measurement carried out, both these families of peaks exhibit comparable line widths. Thus, in the colloidal solution of indium antimonide nanocrystals which is obtained on conclusion of the synthesis, there coexist, on the one hand, particles completely crystallized according to the In_{0.5} Sb_{0.5} cubic phase (characteristic of the bulk material) and, on the other hand, nanocrystals exhibiting solely the In_{0.4}Sb_{0.6} phase.

The photograph obtained by scanning transmission electron microscopy (STEM) (Carl Zeiss Ultra 55+) (FIG. 3) shows that the particles have a mean diameter of 12 nm, with a size dispersion of approximately 22%.

The photograph by high resolution transmission electron microscopy (HRTEM) (JEOL 4000EX, used at 400 kV) of an isolated nanocrystal (box, FIG. 3) confirms for its part that the nanocrystals obtained are highly crystalline. This is because the atomic planes may be distinguished therein.

### 2.2. Synthesis of InSb Nanocrystals with a Mean Size of 85 nm

The following are introduced into the three-necked flask (1):

0.1 mmol of indium acetate (In(Ac)₃)

0.3 mmol of myristic acid (MA)

0.3 mmol of dodecylamine (DDA)

8.6 ml of 1-octadecene (ODE).

The mixture is first placed under stirring and an inert atmosphere and then heated under vacuum at 80° C. for approximately two hours in order to allow it to degass. The indium precursor (indium myristate) is thus formed at this stage. After having re-established the argon circulation, the solution present in the round-bottomed flask (1) is then brought to a temperature of 215° C.

The three-necked flask (2) is in its turn placed under an inert atmosphere and approximately 2 ml of 1 mol/l sulfuric acid solution, degassed beforehand, are introduced therein. 1 ml of 0.8 mol/l potassium hydroxide (KOH) solution (likewise degassed) are subsequently added to the glass flask (a) already containing 0.1 mmol of antimony potassium tartrate (APT). After complete dissolution (an ultrasound bath may advantageously accelerate the process), the mixture is transferred into the flask (b) in which 0.15 mmol of potassium borohydride (KBH₄) has been deposited. The combined mixture is then injected as rapidly as possible into the round-bottomed flask (2) in order to start the production of SbH₃.

The coloration of the initially translucent reaction medium changes to black in a few seconds. After ten minutes, counting from the start of the production of the antimony trihydride, the gas injection needle is removed from the three-necked flask (1) and immersed in a trap containing a silver nitrate solution.

The mixture is subsequently rapidly cooled down to 70-80° C. and then injected into a vessel containing approximately 10 ml of toluene in order to prevent the solidification of the dodecylamine (melting point: 27-29° C.).

On two occasions, the final product is precipitated using methanol and then separated by centrifuging before being redispersed in a few milliliters of chloroform. A stable colloidal solution of InSb nanocrystals in chloroform is thus obtained.

### Characterization of the Nanocrystals

The EDX analysis indicates that the particles produced are approximately 43% composed of indium and approximately 57% composed of antimony.

Furthermore, the X-ray diffraction diagram (FIG. 2, curve b) produced on a deposit of these same nanocrystals comprises peaks corresponding to a “zinc blende” structure identical to that of the bulk indium antimonide (JCPDS card No. 04-001-0014). Other peaks, which are less intense, would appear to originate from a cubic crystalline phase slightly richer in antimony of the In_{0.4}Sb_{0.6} type (JCPDS card No. 01-074-5940).

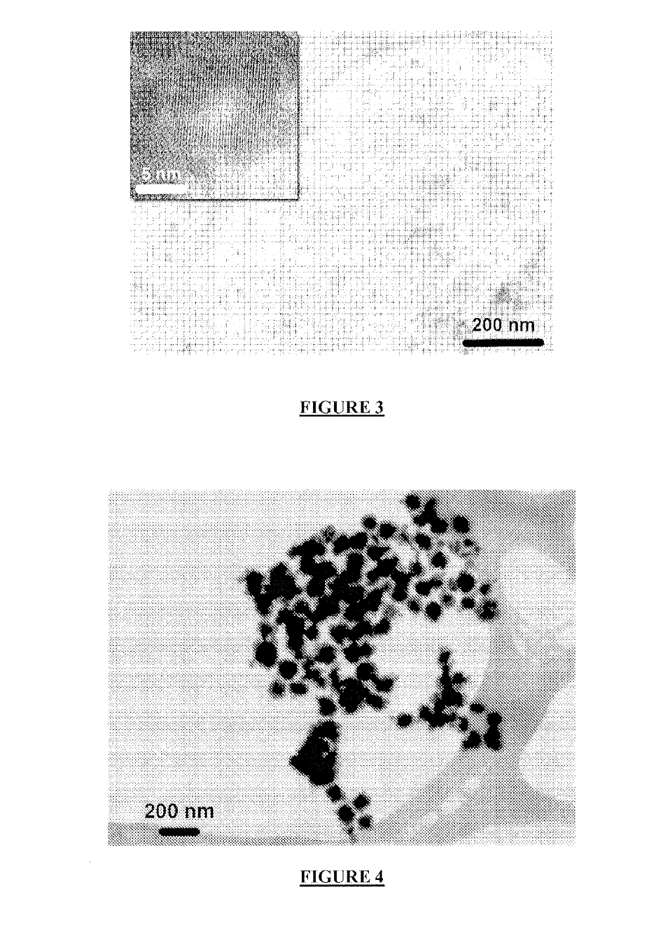

The STEM photograph (FIG. 4) shows that the particles have a mean diameter of 85 nm, with a size dispersion of approximately 20%.

### 2.3. Synthesis of InSb Nanocrystals with a Mean Size of 9 nm

The protocol which follows was carried out using the set-up represented in FIG. 5, which constitutes an adaptation of the set-up described in example 1. Two valves (R1 and R2) have been added for better control of the injection of the gas (FIG. 5).

The protocol carried out starting from the set-up described in FIG. 5 is as follows.

The following are introduced into the three-necked flask (1):

0.2 mmol of indium acetate (In(Ac)₃)

0.6 mmol of myristic acid (MA)

0.6 mmol of dodecylamine (DDA)

8.6 ml of 1-octadecene (ODE).

The mixture is first placed under stirring and an inert atmosphere and then brought to a temperature of approximately 80° C. under low vacuum for approximately one hour in order to allow it to degass. After having re-established the argon circulation, the solution is heated at 220° C. for approximately fifteen minutes in order to form the indium precursor (indium myristate). The solution present in the round-bottomed flask (1) is then brought back to a temperature of 165° C.

The three-necked flask (2) is in its turn placed under an inert atmosphere and approximately 6 ml of 1 mol/l sulfuric acid solution, degassed beforehand, are introduced therein. 3 ml of 0.8 mol/l potassium hydroxide (KOH) solution (likewise degassed) are subsequently added to the glass flask (a) already containing 0.28 mmol of antimony potassium tartrate (APT). After complete dissolution (an ultrasound bath may advantageously accelerate the process), the mixture is transferred into the flask (b) in which 0.42 mmol of potassium borohydride (KBH₄) will have been deposited. After closing the valves R1 and R2, the combined mixture is then injected into the round-bottomed flask (2) in order to start the production of SbH₃.

The pH of the mixture prepared in the flask (b), which is initially basic, is, in contact with acid present in the round-bottomed flask (2), brought to a value of less than 7. This has the effect of initiating the reaction between the APT and KBH₄ powders and of starting, with stirring, the production of the antimony trihydride. The translucent solution present in the round-bottomed flask (2) then rapidly assumes a black coloration. After approximately one minute, the valves R1 and R2 are simultaneously opened in order to allow the free circulation of the gas toward the round-bottomed flask (1).

The initially colorless reaction medium present in the round-bottomed flask (1) rapidly becomes pale yellow. The coloration subsequently changes in a few minutes to dark yellow and then to brown-black, the sign of the growth of the nanocrystals. After approximately 3 minutes, counting from the start of the production of the antimony trihydride, the valves R1 and R2 are simultaneously closed. The gas injection needle is for its part withdrawn from the three-necked flask (1) and immersed in a trap containing a silver nitrate solution.

The nanocrystals thus obtained are annealed at 220° C. for forty-five minutes. The mixture is subsequently rapidly cooled down to 70-80° C. and then injected into a vessel containing approximately 5 ml of toluene in order to prevent the solidification of the dodecylamine.

On two occasions, the final product is precipitated using methanol and then separated by centrifuging before being redispersed in a few milliliters of chloroform. A stable colloidal solution of InSb nanocrystals in chloroform is thus obtained.

### Characterization of the Nanocrystals

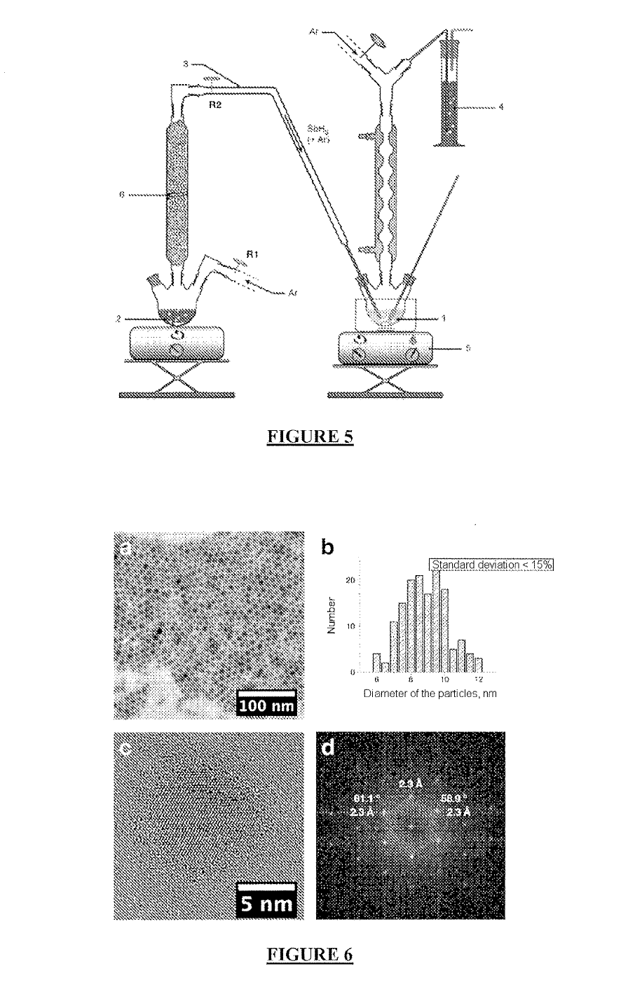

The photograph obtained by scanning transmission electron microscopy (STEM) (Carl Zeiss Ultra 55+) (FIG. 6.a) shows that the particles have a mean diameter of 9 nm, with a size dispersion of less than 15% (FIG. 6.b).

The photograph by high resolution transmission electron microscopy (HRTEM) (Titan Ultimate) of an isolated nanocrystal (FIG. 6.c) for its part confirms that the nanocrystals obtained are highly crystalline. This is because the atomic planes may be distinguished therein. The Fourier transform (FIG. 6.d) of this same nanocrystal shows that the latter exhibits the same structure as the bulk InSb material.

### REFERENCES

[1] Têtu et al., InSb nanocrystals embedded in SiO₂: Strain and melting-point hysteresis, Materials Science and Engineering B, 147, 141-143 (2008)

[2] Usui et al., InSb/Al—) Nanogranular Films Prepared by RF Sputtering, Journal of Physical Chemistry C, 113, 20589-20593 (2009)

[3] Glaser et al., Photoluminescence studies of self-assembled InSb, GaSb, and AlSb quantum dot heterostructures, Applied Physics Letters, 68, 3614-3616 (1996)

[4] Amberger et al., Mixed organometallic compounds of group V I. Synthesis of tris(trimethyl-group-IV)stibines, Journal of Organometallic Chemistry, 8, 111-114 (1967)

[5] Evans et al., Synthesis and Use of Tris(trimethylsilyl)antimony for the Preparation of InSb Quantum Dots, Chemistry of Materials, 20, 5727-5730 (2008)

[6] Schulz et al., Temperature-controlled synthesis of gallium antimonide nanoparticles in solution, Materials Research Bulletin, 34, 2053-2059 (1999)

[7] Li et al., Solvothermal Reduction Synthesis of InSb Nanocrystals, Advanced Materials, 13, 145-148 (2001)

1.-23. (canceled)

24. A process for the preparation of nanoparticles of antimonides of metal element(s), in the form of a colloidal solution, employing antimony trihydride (SbH₃) as antimony source.

25. The process as claimed in claim 24, in which the nanoparticles of antimonides of metal element(s) are of generally spherical shape.

26. The process as claimed in claim 24, in which said metal element is chosen from aluminum (Al), gallium (Ga), indium (In), thallium (Tl), zinc (Zn), cadmium (Cd), iron (Fe), cobalt (Co), nickel (Ni), bismuth (Bi), scandium (Sc), titanium (Ti), vanadium (V), chromium (Cr), manganese (Mn), copper (Cu), rubidium (Rb), strontium (Sr), yttrium (Y), zirconium (Zr), niobium (Nb), ruthenium (Ru), rhodium (Rh), palladium (Pd), silver (Ag), cesium (Cs), barium (Ba), hafnium (Hf), iridium (Ir), platinum (Pt), gold (Au), tin (Sn), lead (Pb) and their mixtures.

27. The process as claimed in claim 24, in which the antimony trihydride is formed from an aqueous solution of acidic pH of antimony potassium tartrate, and potassium borohydride.

28. The process as claimed in claim 24, in which the nanocrystals are subjected to a subsequent stage of thermal annealing.

29. The process as claimed in claim 28, in which the thermal annealing is operated at a temperature ranging from 200 to 300° C.

30. The process as claimed in claim 28, said thermal annealing being carried out for a period of time ranging from 30 minutes to 4 hours.

31. The process as claimed in claim 24, for the preparation of indium antimonide (InSb) nanoparticles.

32. The process as claimed in claim 24, comprising at least one stage in which antimony trihydride and at least one precursor of a metal element are brought together under conditions favorable to the formation of said nanoparticles.

33. The process as claimed in claim 32, in which said precursor of the metal element is a complex of said metal element with a fatty acid having a saturated or unsaturated and linear or branched carbon chain comprising between 4 and 36 carbon atoms.

34. The process as claimed in claim 32, in which said precursor of the metal element is a complex of said metal element with a fatty acid having a linear alkyl chain comprising between 12 and 18 carbon atoms.

35. The process as claimed in claim 34, in which said fatty acid is chosen from lauric acid, myristic acid, palmitic acid, stearic acid and oleic acid.

36. The process as claimed in claim 32, in which said indium precursor is indium myristate.

37. The process as claimed in claim 36, said indium myristate being obtained from indium acetate and myristic acid.

38. The process as claimed in claim 24, comprising at least the stages consisting in:
(i) providing a liquid medium, referred to as reaction medium, comprising at least one precursor of a metal element and at least one solvent; and
(ii) bringing together the antimony trihydride and said reaction medium under conditions favorable to the formation of said nanoparticles.

39. The process as claimed in claim 38, in which stage (ii) comprises the injection of the antimony trihydride into said reaction medium.

40. The process as claimed in claim 38, in which the antimony trihydride is formed simultaneously with its use in stage (ii).

41. The process as claimed in claim 38, in which said precursor of the metal element is formed beforehand by reaction in said solvent of an organic or inorganic salt of said metal element with a fatty acid having a saturated or unsaturated and linear or branched carbon chain comprising between 4 and 36 carbon atoms.

42. The process as claimed in claim 38, in which said precursor of the metal element is formed beforehand by reaction in said solvent of an organic or inorganic salt of said metal element with a fatty acid having a linear alkyl chain comprising between 12 and 18 carbon atoms.

43. The process as claimed in claim 42, in which said fatty acid is chosen from lauric acid, myristic acid, palmitic acid, stearic acid and oleic acid.

44. The process as claimed in claim 38, in which said solvent is an organic compound exhibiting a boiling point of greater than 150° C.

45. The process as claimed in claim 38, in which said solvent is chosen from saturated or unsaturated hydrocarbons.

46. The process as claimed in claim 38, in which said solvent is 1-octadecene.

47. The process as claimed in claim 38, in which said reaction medium additionally comprises one or more ligands.

48. The process as claimed in claim 47 in which said ligands are chosen from amines.

49. The process as claimed in claim 48, in which said amine is chosen from octylamine, decylamine, dodecylamine, tetradecylamine, hexadecylamine and oleylamine.

50. The process as claimed in claim 38, in which said reaction medium is maintained, in stage (ii), at a temperature T₂ ranging from 140 to 250° C.

51. The process as claimed in claim 38, in which said reaction medium is maintained, in stage (ii), at a temperature T₂ ranging from 150 to 220° C.

52. A colloidal solution of nanoparticles of antimonides of metal element(s), obtainable according to a process employing antimony trihydride (SbH₃) as antimony source.

53. A colloidal solution of indium antimonide nanoparticles, comprising nanocrystals crystallized according to the In_{0.5}Sb_{0.5} cubic phase and nanocrystals crystallized according to the In_{0.4}Sb_{0.6} phase, said nanoparticles exhibiting a size dispersion of less than 30%.

54. A process for the preparation of solar cells, photodetectors, light converters, light-emitting diodes, transistors, fluorescent markers or chemical or optical sensors, using a colloidal solution of nanoparticles of antimonides of metal element(s) obtainable according to a process employing antimony trihydride (SbH₃) as antimony source.

55. A process for the preparation of solar cells, photodetectors, light converters, light-emitting diodes, transistors, fluorescent markers or chemical or optical sensors, using a colloidal solution of indium antimonide nanoparticles, comprising nanocrystals crystallized according to the In_{0.5}Sb_{0.5} cubic phase and nanocrystals crystallized according to the In_{0.4}Sb_{0.6} phase, said nanoparticles exhibiting a size dispersion of less than 30%.
